(19) United States
(12) Patent Application Publication
(10) Pub. No.: US 2026/0277896 A1
(43) Pub. Date: Sep. 17, 2026

(54) ADAPTIVE DEPLOYMENT PLAN GENERATION FOR MACHINE LEARNING-BASED APPLICATIONS IN EDGE CLOUD

(71) Applicant: Telefonaktiebolaget LM Ericsson (publ), Stockholm (SE)

(72) Inventors: Chunyan FU, Pointe-Claire (CA); Carla MOURADIAN, Montreal (CA); Fetahi WUHIB, Pincourt (CA); Mbarka SOUALHIA, Laval (CA); Wubin LI, Kirkland (CA)

(73) Assignee: Telefonaktiebolaget LM Ericsson (publ), Stockholm (SE)

(21) Appl. No.: 19/168,037

(22) PCT Filed: Apr. 18, 2023
(86) PCT No.: PCT/IB2023/053971

§ 371 Date: Sep. 23, 2025

(51) Int. Cl. G06F 16/2453

(52) U.S. Cl. CPC G06F 16/24542

(57) ABSTRACT

A computer-implemented method for generating a deployment plan for a machine learning-based application. The method includes obtaining constraint sets of the application, obtaining candidate sets, and filtering the candidate sets based on applying the constraint sets to corresponding candidate sets in a sequence that minimizes estimated remaining searching costs. The filtering results in generating filtered candidate sets including a filtered candidate set of models, a filtered candidate set of data sources, and a filtered candidate set of sites. The method further includes selecting a model from the filtered candidate set of models, selecting one or more data sources from the filtered candidate set of data sources, selecting one or more sites from the filtered candidate set of sites, and generating a deployment plan for the application that specifies the selected model, the selected one or more data sources, and the selected one or more sites.

### TECHNICAL FIELD

Embodiments of the invention relate to the field of machine learning-based applications, and more specifically, to generating a deployment plan for a machine learning-based application.

### BACKGROUND

Machine learning (ML) is a field of inquiry devoted to understanding and building methods that “learn”—that is, methods that leverage data to improve the performance of a set of tasks. ML can be seen as a form of artificial intelligence (AI). Machine learning algorithms build a model based on sample data, sometimes referred to as training data, in order to make predictions or decisions without being explicitly programmed to do so. Machine learning algorithms are used in a wide variety of applications such as in medicine, email filtering, speech recognition, agriculture, and computer vision, or other applications where it is difficult or unfeasible to develop conventional algorithms to perform the needed tasks. An application that leverages ML techniques may be referred to as an ML-based application.

A typical workflow for deploying an ML-based application involves selecting ML models that the application will use for inferencing, selecting data sources that can provide training data, preparing the training data, training the ML model using the training data, and deploying the application to a site that has the resources (e.g., central processing unit (CPU), memory, and networking resources) to execute the ML-based application. The workflow can be particularly challenging to implement when the ML-based application is to be deployed in an edge cloud environment due to the complexity, dynamicity, and heterogeneity of edge clouds.

Existing workflows for deploying an ML-based application in an edge cloud involves selecting ML models, data sources, and sites that satisfy the application requirements and operator policies (e.g., cloud operator's policies). Existing workflows rely on human experts to select the appropriate ML models, data sources, and/or sites for application deployments, which can be time-consuming and sometimes inefficient.

### SUMMARY

A method performed by one or more computing devices is disclosed for generating a deployment plan for a machine-learning-based application. The method may include obtaining constraint sets of the application including a constraint set for models, a constraint set for data sources, and a constraint set for sites, obtaining candidate sets including a candidate set of models, a candidate set of data sources, and a candidate set of sites, filtering the candidate sets based on applying the constraint sets to corresponding candidate sets in a sequence that minimizes estimated remaining searching costs, wherein the filtering results in generating filtered candidate sets including a filtered candidate set of models, a filtered candidate set of data sources, and a filtered candidate set of sites, selecting a model from the filtered candidate set of models, selecting one or more data sources from the filtered candidate set of data sources, selecting one or more sites from the filtered candidate set of sites, and generating a deployment plan for the application that specifies the selected model, the selected one or more data sources, and the selected one or more sites.

A non-transitory machine-readable storage medium is disclosed storing computer program code, which when executed by a computer, causes the computer to carry out a method for generating a deployment plan for a machine-learning-based application. The method may include obtaining constraint sets of the application including a constraint set for models, a constraint set for data sources, and a constraint set for sites, obtaining candidate sets including a candidate set of models, a candidate set of data sources, and a candidate set of sites, filtering the candidate sets based on applying the constraint sets to corresponding candidate sets in a sequence that minimizes estimated remaining searching costs, wherein the filtering results in generating filtered candidate sets including a filtered candidate set of models, a filtered candidate set of data sources, and a filtered candidate set of sites, selecting a model from the filtered candidate set of models, selecting one or more data sources from the filtered candidate set of data sources, selecting one or more sites from the filtered candidate set of sites, and generating a deployment plan for the application that specifies the selected model, the selected one or more data sources, and the selected one or more sites.

### BRIEF DESCRIPTION OF THE DRAWINGS

The invention may best be understood by referring to the following description and accompanying drawings that are used to illustrate embodiments of the invention. In the drawings:

FIG. 1 is a diagram showing the input and output of a deployment plan generator, according to some embodiments.

FIG. 2 is a diagram showing an environment in which a deployment plan can be generated, according to some embodiments.

FIG. 3 is a flow diagram of a method performed by the deployment plan generator for deciding on a deployment plan to use for an application, according to some embodiments.

FIG. 4 is a flow diagram of a method performed by the deployment plan generator for generating a new deployment plan, according to some embodiments.

FIG. 5 is a flow diagram of a method performed by a deployment plan generator for minimizing estimated remaining searching costs, according to some embodiments.

FIG. 6 is a flow diagram of a process performed by the deployment plan generator for generating a deployment plan that satisfies operator policies, according to some embodiments.

FIG. 7 is a diagram showing a sequence of operators for deploying an application, according to some embodiments.

FIG. 8 shows a configuration file that summarizes the application requirements of the example system load forecasting use case, according to some embodiments.

FIG. 9 is a diagram showing an example deployment plan generation, according to some embodiments.

FIG. 10 is a flow diagram of a method for generating a deployment plan for a machine learning-based application, according to some embodiments.

FIG. 11A illustrates connectivity between network devices (NDs) within an exemplary network, as well as three exemplary implementations of the NDs, according to some embodiments of the invention.

FIG. 11B illustrates an exemplary way to implement a special-purpose network device according to some embodiments of the invention.

### DETAILED DESCRIPTION

The following description describes methods and apparatus for generating a deployment plan for a machine learning (ML)-based application. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, existing workflows for deploying an ML-based application in an edge cloud involves selecting ML models, data sources, and sites that satisfy the application requirements and operator policies (e.g., cloud operator's policies). Existing workflows rely on human experts to select the appropriate ML models, data sources, and/or sites for application deployments, which can be time-consuming and sometimes inefficient.

Embodiments disclosed herein provide a deployment plan generator that can automatically (e.g., without human intervention or with minimal human intervention) generate a deployment plan for an ML-based application that satisfies the application requirements. According to some embodiments, a deployment plan generator obtains constraint sets of the application including a constraint set for models, a constraint set for data sources, and a constraint set for sites. The constraint sets may be obtained based on parsing and analyzing the application requirements. The deployment generator may also obtain candidate sets including a candidate set of models, a candidate set of data source, and a candidate set of sites. These candidate sets represent the models, data sources, and sites that are available for application deployments. The deployment generator may filter the candidate sets based on applying the constraint sets to their corresponding candidate sets in a sequence that minimizes estimated remaining searching costs (to minimize the remaining search space). The filtering results in generating filtered candidate sets including a filtered candidate set of models, a filtered candidate set of data sources, and a filtered candidate set of sites. These filtered candidate sets represent the models, data sources, and sites that satisfy the application requirements. Any combination of <model, data source, site> selected from the filtered candidate sets will satisfy the application requirements. The deployment plan generator selects a model from the filtered candidate set of models, selects one or more data sources from the filtered candidate set of data sources, and selects one or more sites from the filtered candidate set of sites. The deployment plan generator may then generate a deployment plan for the application that specifies the selected model, the selected one or more data sources, and the selected one or more sites. The deployment plan generator may provide the generated deployment plan to an application execution environment. The application execution environment may deploy the application according to the deployment plan (e.g., train the selected model using training data provided by the selected data sources and deploy the selected model to the selected sites) and execute the application.

In some embodiments, the deployment plan generator stores a historical application execution record that includes information regarding the deployment plan that was used to deploy the application and performance metrics associated with the deployment plan. The performance metrics associated with the deployment plan may be the performance metrics of the application that was deployed using the deployment plan. If the deployment plan generator receives a request to generate a deployment plan for a new application that has sufficiently similar requirements/constraints as a previously-deployed application, the deployment plan generator may decide that the same or similar deployment plan that was used to deploy the previously-deployed application can be used to deploy the new application if the performance metrics associated with the deployment plan indicate that the previously-deployed application performed at a sufficiently high level (e.g., the previously-deployed application satisfied its requirements such as performance indicators (KPIs) requirements).

A technical advantage of some embodiments disclosed herein is that they consider the order of applying constraint sets to candidate sets when generating a deployment plan to reduce the estimated remaining searching costs (e.g., to minimize the search space). Existing solutions do not consider the order of applying constraints when orchestrating an ML-based application. Reducing the estimated remaining searching costs helps improve efficiency.

A technical advantage of some embodiments disclosed herein is that they provide a holistic solution that automates various sub-workflows of the application deployment process such as ML model selection, data source selection, and site selection. Existing solutions primarily focus on optimizing one specific sub-workflow but do not provide a holistic automated solution.

A technical advantage of some embodiments disclosed herein is that they enable continuous optimization by learning from previous deployment decisions. For example, embodiments may reuse a previously-generated deployment plan if it has a sufficiently high success rate. Also, embodiments can train an ML model to estimate remaining searching costs. This can result in improving efficiency and making improved deployment decisions, which in turn may result in improved performance for the application and/or more efficient resource usage in the edge cloud.

While certain technical advantages are mentioned above, other technical advantages will be apparent to those skilled in the art in view of the present disclosure.

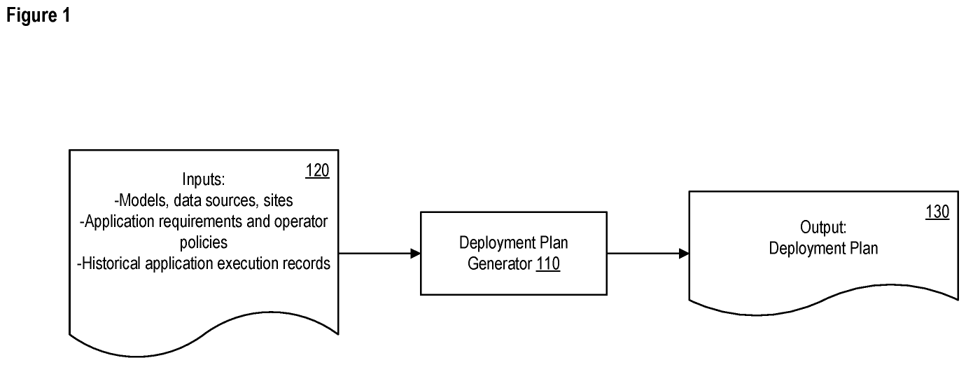

FIG. 1 is a diagram showing the input and output of a deployment plan generator, according to some embodiments.

As shown in the diagram, a deployment plan generator 110 may receive one or more inputs 120 and generate an output 130. The inputs 120 may include candidate sets, the application requirements and operator policies, and historical application execution records. The output may include a deployment plan.

The candidate sets may include a candidate set of models, a candidate set of data sources, and a candidate set of sites. The candidate set of models may include ML models that can perform inferencing. The candidate set of data sources may include data sources that can provide training data for training models. The candidate set of sites may include sites (e.g., edge sites in an edge cloud) that have the resources (e.g., computing, memory, and/or networking resources) that can execute ML-based applications.

The application requirements may include constraint sets including a constraint set for models, a constraint set for data sources, and a constraint set for sites. The constraint set for models may include constraints that are applicable to models. The constraint set for data sources may include constraints that are applicable to data sources. The constraint set for sites may include constraints that are applicable to sites.

The operator policies may include one or more policies defined by the operator (e.g., the edge cloud operator). For example, the operator policies may include a policy indicating resource usage should be minimized, a policy indicating that the use of specific sites is required or preferred, a policy indicating that data privacy is to be maintained, and/or a policy indicating the maximum cost to be used.

The historical application execution records may include information regarding previous deployment plans that were used to deploy applications and the performance metrics associated with those deployment plans. The performance metrics associated with a deployment plan may be the performance metrics of an application that was deployed using the deployment plan. In an embodiment, a historical application execution record includes information regarding a previously-deployed application (e.g., its requirements/constraints), a deployment plan that was used to deploy that application, and performance metrics associated with the deployment plan.

As mentioned above, the output of the deployment plan generator 110 may include a deployment plan. As will be described in additional detail herein, the deployment plan generator 110 may generate the deployment plan such that it satisfies the application requirements and operator policies. The deployment plan may specify the model that the application can use, the data sources that can provide training data for training the model, and the sites where the application can be deployed.

In an embodiment, if the deployment plan generator 110 receives a request to generate a deployment plan for a new application, the deployment plan generator 110 searches through the historical application execution records to look for a previously-generated deployment plan that was generated based on constraints similar to the constraints of the new application. If the deployment plan generator 110 finds a previously-generated deployment plan that was generated based on similar constraints and that has a sufficiently high success rate (what is sufficiently high can be configurable), the deployment plan generator 110 may decide to reuse the previous-generated deployment plan for the new application. Otherwise, if the deployment plan generator 110 is unable to find such a previously-generated deployment plan, then the deployment plan generator 110 may decide to generate a new deployment plan for the new application that fulfills the application requirements and operator policies. As will be described in additional detail herein, the deployment plan generator 110 may generate a deployment plan based on applying constraint sets of the application to corresponding candidate sets in a sequence that minimizes the estimated remaining searching costs.

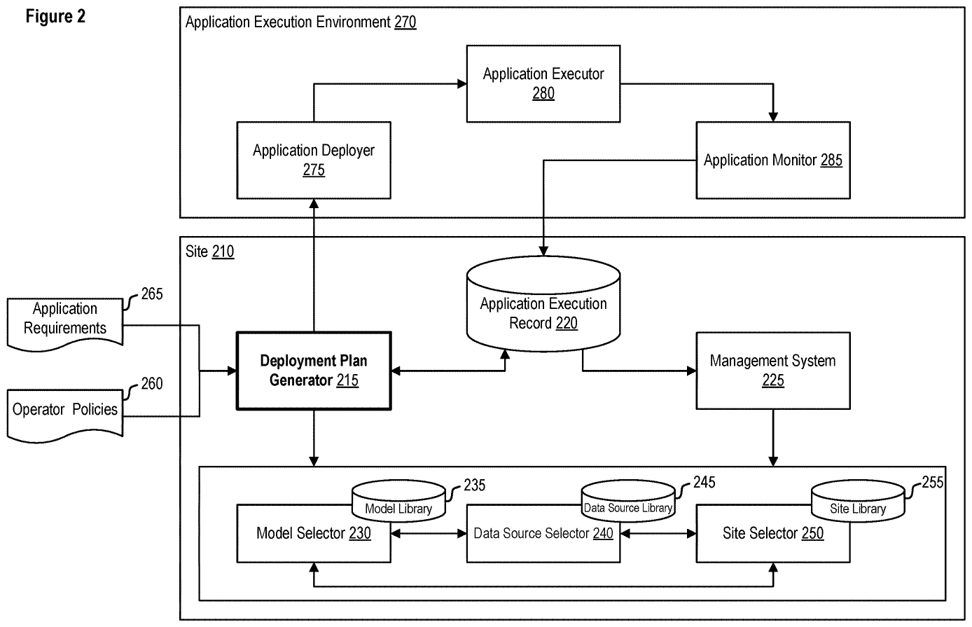

FIG. 2 is a diagram showing an environment in which a deployment plan can be generated, according to some embodiments.

As shown in the diagram, the environment includes a site 210 and an application execution environment 270. The site 210 may be a central site or an edge site of a network. The site 210 may include a deployment plan generator 215, an application execution record database 220, a management system 225, a model selector 230, a data source selector 240, and a site selector 250. The model selector 230 may have access to a model library 235. The model library 235 may include information regarding one or models that can be used by ML-based applications for inferencing. The data source selector 240 may have access to a data source library 245. The data source library 245 may include information regarding one or more data sources that can provide training data for training ML models. The site selector 250 may have access to a site library 255. The site library 255 may include information regarding one or more sites that have resources for executing ML-based applications.

The deployment plan generator 215 may obtain the requirements 265 of an application to be deployed and operator policies 260. The deployment plan generator 215 may parse the application requirements 265 to determine constraint sets of the application. The constraint sets of the application may include a constraint set for models, a constraint set for data sources, and a constraint set for sites. The deployment plan generator 215 may determine the sequence with which to apply the constraint sets to corresponding candidate sets. Thus, the deployment plan generator 110 may determine the sequence in which the model selector 230, the data source selector 240, and the site selector 250 should apply constraint sets to candidate sets in order to minimize the estimated remaining searching costs.

The deployment plan generator 110 may search the historical application execution records stored in the application execution record database 220 for any previously-generated deployment plans that were generated based on similar requirements/constraints as the constraints of the application to be deployed. The deployment plan generator 110 may decide to use one of the previously-generated deployment plans if the previously-generated deployment plan has a success rate that is greater than a threshold success rate (e.g., if the performance metrics associated with the deployment plan indicate that the application that was deployed using the deployment plan performed at a sufficiently high level). If none of the previously-generated deployments have a sufficiently high success rate, then the deployment plan generator 110 may decide to generate a new deployment plan for the application instead of reusing a previously-generated deployment plan. Once the deployment plan generator 215 decides on a deployment plan to use for the application, the deployment plan generator 215 may provide the deployment plan to the application deployer 275.

The model selector 230 may determine which models in the model library 235 satisfy the application requirements and operator policies. In an embodiment, the model selector 230 makes this determination by performing one or more of the following steps: purpose matching, filtering based on model requirements, and resource matching.

In the purpose matching step, the model selector 230 may determine which of the models in the model library 235 match the AI/ML purpose of the application. The AI/ML purpose of the application may represent the type of inferencing that the application is to perform. The model selector 230 may exclude (i.e., filter out) any models that do not match the AI/ML purpose of the application.

In the filtering based on model requirement step, the model selector 230 may determine which of the models in the model library 235 satisfy the model requirements. For example, the model selector 230 may exclude (i.e., filter out) any models that do not satisfy model accuracy requirements and/or exclude any models that require a certain amount of training data that is not available (e.g., by coordinating with the data source selector 240, possibly with the assistance of the deployment plan generator 215).

In the resource matching step, the model selector 230 may determine which of the models in the model library 235 have resource requirements that can be met by the available edge sites. For example, the model selector 230 may exclude (i.e., filter out) any models that require resources that are not available at the edge sites (e.g., by coordinating with the site selector 250, possibly with the assistance of the deployment plan generator 215).

The data source selector 240 may determine which data sources in the data source library 245 can provide data that satisfies the application requirements and operator policies. In an embodiment, if the data source selector 240 is given a candidate set of models, then the data source selector 240 determines the data requirements of these models and excludes (i.e., filters out) the data sources in the data source library 245 that are not able to provide data that satisfies the data requirements. Otherwise, if the data source selector 240 is not given a candidate set of models, then the data source selector 240 may exclude the data sources in the data source library 245 that are not able to satisfy the application requirements.

The site selector 250 may determine which sites in the site library 255 satisfy the application requirements and operator policies. For example, the site selector 250 may exclude (i.e., filter out) the sites in the site library 255 that do not have the resources necessary to perform data processing, model training, and/or model inferencing in a manner that satisfies the application requirements and the operator policies. In an embodiment, the site selector 250 determines which sites satisfy the application requirements and operator policies based on executing a placement algorithm that takes into account the application requirements and operator policies.

The management system 225 may manage data sources and models. In an embodiment, the management system 225 includes a data management component that processes collected data so that it is usable by the ML model. In an embodiment, the management system includes a model management component that continuously retrains, reevaluates, deploys, and monitors ML models. For example, the management system 225 may collect execution records of the ML models. The management system 225 may save the selected data, data sources, and sites for an ML model to be deployed. The management system 225 may continuously evaluate and monitor the execution of the ML models and save the results (e.g., accuracy, time, etc.). Management system parameters may include execution records, success rate of application deployment, the selected data sources/sites/models, etc.

The application execution record database 220 may store historical application execution records. A historical application execution record may include information regarding a deployment plan that was used to deploy an application and performance metrics associated with the deployment plan (e.g., indicating how well the application ran once deployed).

The application deployer 275 may obtain a deployment plan (e.g., from the deployment plan generator 215) and deploy an application in the application execution environment 270 according to the deployment plan. For example, the application deployer 275 may deploy an application (with a trained model) to one or more sites specified in the application deployment plan.

The application executor 280 may manage the execution of an application. In an embodiment, the application executor 280 includes or otherwise has access to application code, application programming interfaces (APIs), and/or supplementary tools that can be used to manage application execution.

The application monitor 285 may monitor/measure the performance of executing applications and update the corresponding historical application execution records in the application execution record database 220 with performance metrics.

While a certain arrangement of components is shown in the diagram, those skilled in the art will appreciate that some embodiments can be implemented using a different arrangement. While the diagram shows the selectors (e.g., model selector 230, data source selector 240, and the site selector 250 as being separate from the deployment plan generator 215), in some embodiments, the selectors may be subcomponents of the deployment plan generator 215.

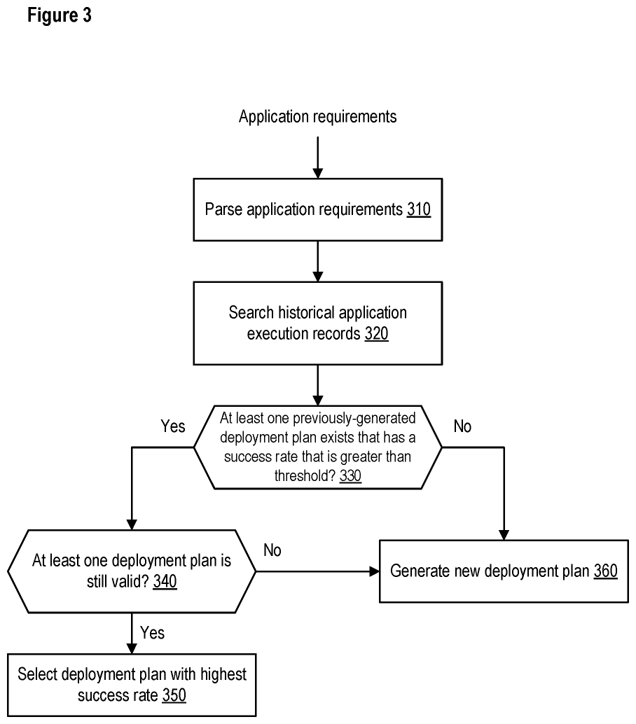

FIG. 3 is a flow diagram of a method performed by the deployment plan generator for deciding on a deployment plan to use for an application, according to some embodiments.

The deployment plan generator may receive the application requirements of the application to be deployed and operator policies as input. The deployment plan generator may also receive a candidate set of models, a candidate set of data sources, and a candidate set of sites as input.

As shown in the diagram, at operation 310, the deployment plan generator parses the application requirements. The application requirements may include the AI/ML application purpose, KPI parameters, constraints (e.g., in terms of cost and location), model requirements (e.g., accuracy, type, etc.), and optimization objectives. The deployment plan generator may determine a constraint set for models, a constraint set for data sources, and a constraint set for sites based on parsing the application requirements.

At operation 320, the deployment plan generator searches historical application execution records for previously-generated deployment plans that were generated based on similar requirements/constraints as the application to be deployed.

At operation 330, the deployment plan generator determines whether at least one such deployment plan exists that has a success rate that is greater than a threshold success rate. The success rate of a deployment plan may indicate how well an application that was deployed using the deployment plan performed. If at least one deployment plan is found, then the flow moves to operation 340. Otherwise, the flow moves to operation 360.

At operation 340, the deployment plan generator determines whether at least one of the deployment plans is still valid. The validity of the deployment plan may be affected by various factors such as the dynamicity of the environment. If at least one of the deployment plans is still valid, then the flow moves to operation 350. Otherwise, the flow moves to operation 360.

At operation 350, the deployment plan generator selects the deployment plan with the highest success rate.

At operation 360, the deployment plan generator generates a new deployment plan. As will be described in additional detail herein, the deployment plan generator may generate a deployment plan that satisfies the application requirements and the operator policies, while minimizing the estimated remaining searching costs of the models, data sources, and sites.

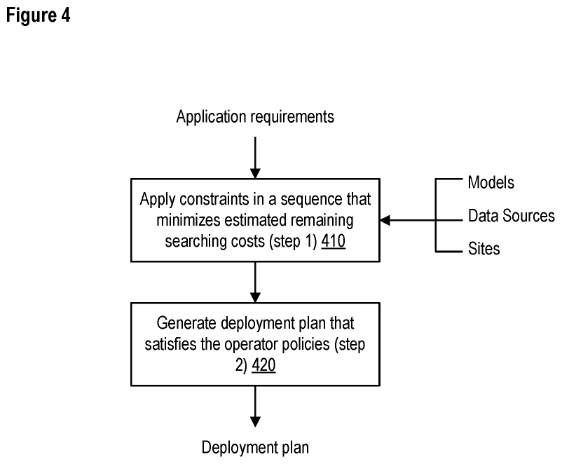

FIG. 4 is a flow diagram of a method performed by the deployment plan generator for generating a new deployment plan, according to some embodiments.

The goal of the deployment plan generator is to identify, among all possible candidates, the best model, the best data source, and the best site to use for deploying an ML-based application. A naïve solution takes all possible combinations of <model, data source, site> and determines whether each combination satisfies the application requirements. The naïve solution is inefficient because it may require searching through a very large search space to find the optimal combination. For example, if there are 1,000 models, 10,000 data sources, and 100 sites available, then the naive solution has to potentially search through one billion possible combinations. To avoid such inefficiency, embodiments use an iterative approach that deals with one selector at a time.

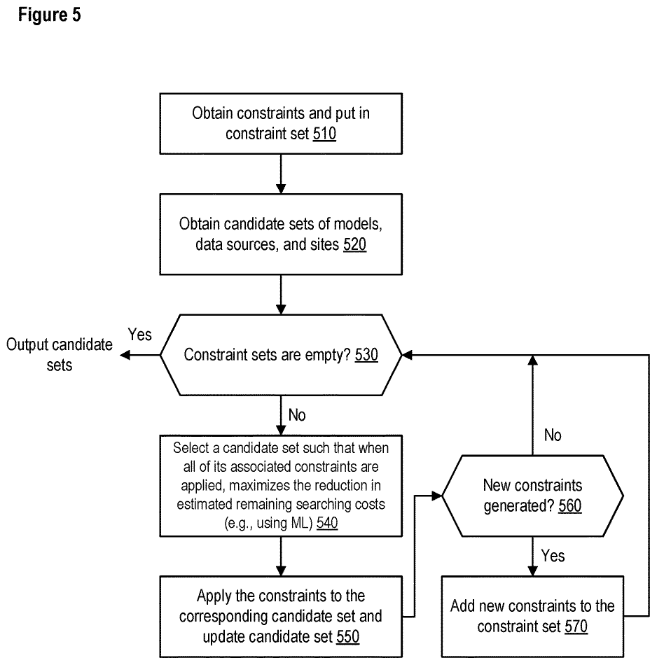

As shown in the diagram, at a high level, the deployment plan generator may perform two steps to generate a new deployment plan. The deployment plan generator may receive the application requirements and candidate models, data sources, and sites as input. At operation 410 (“step 1”) , the deployment plan generator applies constraints to candidates in a sequence that minimizes the estimated remaining searching costs. Step 1 produces filtered candidate sets (applying the constraints “filters out” candidates that are not able to satisfy the application requirements). After step 1, all remaining combinations of <model, data source, site> are possible solutions that can satisfy the application requirements. Further details of this step are shown in FIG. 5.

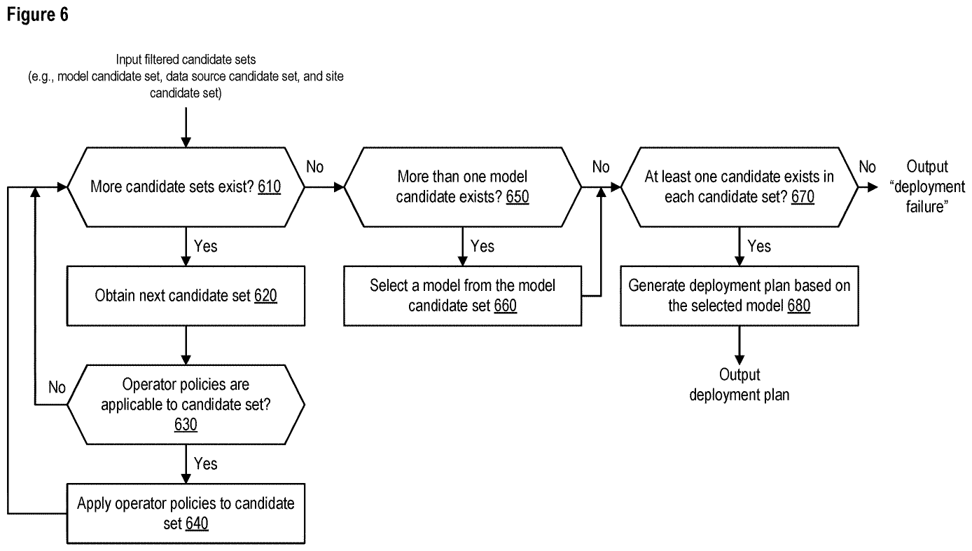

At operation 420 (“step 2”) , the deployment plan generator generates a deployment plan that satisfies the operator policies. As part of this operation, the deployment plan generator may process the remaining candidates (the filtered candidate sets) to determine the best <model, data source, site> combination that satisfies the operator policies. Further details of this step are shown in FIG. 6.

FIG. 5 is a flow diagram of a method performed by a deployment plan generator for minimizing estimated remaining searching costs, according to some embodiments.

At operation 510, the deployment plan generator obtains constraints and puts them in constraint sets. The constraint sets may include a constraint set for models, a constraint set for data sources, and a constraint set for sites. Applying a constraint set to a candidate set has the general effect of reducing the number of candidates in the candidate set (by excluding or filtering out candidates that do not satisfy the constraints in the constraint set). For example, if there are 100 possible candidate models and only five of them can be used to forecast a particular metric, then applying a constraint that requires the ability to forecast the particular metric may result in reducing the number of candidates in the candidate set from 100 to 5.

It should be appreciated that there may be several ways to specify a constraint. Some constraints may be specified in terms of keyword matching (e.g., “metric forecasting”). Other constraints may be specified in terms of a numerical value and a threshold (e.g., inference accuracy must be greater than 90 percent). In an embodiment, several constraints may be specified at the same time (e.g., a univariate, metric forecasting model capable of inference accuracy greater than 90 percent). The way that constraints are specified may be implementation specific.

It should be noted that applying a constraint may result in further constraints being generated for other types of candidates. For example, applying a “metric forecasting” ability constraint to candidate models may imply that a “number of data points>10000” constraint has to be applied to the candidate data sources. The generation of further constraints may be highly dependent on the specific constraint being applied and the implementation details.

It is assumed that there is a method for applying constraints to candidate sets, and that this incurs some cost (e.g., in terms of CPU cycles). For example, a naïve method of applying a constraint to a candidate set may iterate through each candidate in the candidate set and determine whether the candidate satisfies the constraint (e.g., determine whether the candidate should be included or excluded). For such a method, the cost of applying the constraint may be given by the number of candidates in the candidate set multiplied by the cost of determining whether a candidate satisfies the constraint. As a non-limiting example, the cost per candidate may be expressed in terms of the number of CPU cycles that it takes to determine whether a candidate satisfies the constraint or not. Those skilled in the art will appreciate that the particular way of applying constraints and calculating the cost of applying a constraint is implementation specific, and can be realized in a variety of ways.

It should be noted that the sequence in which constraints are applied can affect how much the search space can be reduced (and thus affects the remaining searching costs). For example, applying model constraints first may reduce the number of models from ten to five.

Some of the five remaining models may require specific hardware, which results in having to exclude four out of the ten sites. However, if site constrains are applied first, the number of sites may be reduced from ten to five, and some of the five remaining sites may have limited resources, which results in excluding seven out of the ten models (thus there are three remaining models). The model constraints may then be applied to the three remaining models.

At operation 520, the deployment plan generator obtains candidate sets of models, data sources, and sites. Each candidate set may include the possible candidates of a certain type, along with the attributes on which constraints can be applied. For example, the candidate set of sites may include information about each site in a distributed cloud, along with attributes about each site such as the type and availability of hardware (HW) and software (SW) resources, the geographical location, etc. Those skilled in the art will appreciate that the attributes of the candidates are implementation-specific, and can be realized in a variety of ways.

The method may enter into a loop of performing operations 530-570 while there is at least one constraint in the constraint sets.

At operation 530, the deployment plan generator determines whether the constraint sets are empty. If the constraint sets are empty, this means that all constraints have been applied and thus the deployment plan generator outputs the candidate sets. Otherwise, if the constraint sets are not empty, then the flow moves to operation 540.

At operation 540, the deployment plan generator selects a candidate set such that when its associated constraints are applied, the estimated reduction in searching costs is maximized. In an embodiment, the deployment plan generator applies constraints within a constraint set in a particular order. For example, the deployment plan generator may select a constraint from the constraint set such that if the constraint is applied to the candidate set, the difference between the cost of applying the constraint and the cost of applying a subsequent constraint to the candidate set is maximal. It is noted that the cost can be estimated without actually applying the constraint. For example, this can be achieved by continuously training an ML model for each constraint type to estimate the cost reduction. The ML models may be continuously trained with immediate feedback since the actual cost can be determined after a constraint is actually applied.

In an embodiment, the deployment plan generator uses ML techniques to estimate the remaining searching costs. For example, a regression model (e.g., decision tree) can be used to determine the remaining searching cost. The input of the regression model may be a sequence of constraints (e.g., a particular sequence of model constraints, data source constraints, and site constraints) and a search space (e.g., candidate set of models, candidate set of sources, and candidate set of sites). The output of the regression model may be the estimated remaining searching costs after applying the constraints to the search space. The regression model can be continuously trained after using actual remaining searching costs after applying a sequence of constraints. Although the use of a regression model is mentioned above, it is possible to use other types of ML models and techniques to estimate remaining searching costs. Also, it is possible to use other techniques such as heuristics and/or optimization-based approaches to estimate remaining searching costs.

At operation 550, the deployment plan generator applies the constraints to the corresponding candidate set and updates the candidate set. In general, applying the constraints to the corresponding candidate set will have the effect of reducing the number of candidates in the candidate set (due to excluding candidates that do not satisfy the constraints). It should be noted that applying constraints can produce new constraints.

At operation 550, the deployment plan generator determines whether new constraints are generated. If new constraints are generated, then the flow moves to operation 570. Otherwise, if new constraints are not generated, then the flow moves back to operation 530.

At operation 570, the deployment plan generator adds the new constraints to the appropriate constraint set. The flow then moves back to operation 530. The method outputs candidate sets that have been filtered based on applying constraints.

FIG. 6 is a flow diagram of a process performed by the deployment plan generator for generating a deployment plan that satisfies operator policies, according to some embodiments.

The deployment plan generator receives the filtered candidate sets (e.g., a model candidate set, a data source candidate set, and a site candidate set). The filtered candidate sets may be the output of the method shown in FIG. 5.

At operation 610, the deployment plan generator determines whether more candidate sets exist. If more candidate sets exist, then the flow moves to operation 620. Otherwise, if more candidate sets do not exist, then the flow moves to operation 650.

At operation 620, the deployment plan generator obtains the next candidate set.

At operation 630, the deployment plan generator determines whether the operator policies are applicable to the candidate set. If the operator policies are applicable to the candidate set, then the flow moves to operation 640. Otherwise, if the operator policies are not applicable to the candidate set, then the flow moves back to operation 610.

At operation 640, the deployment plan generator applies the operator policies to the candidate set.

At operation 650, the deployment plan generator determines whether more than one model candidate exists. If more than one model candidate exists, then the flow moves to operation 660. Otherwise, if more than one model candidate does not exist, then the flow moves to operation 670.

At operation 660, the deployment plan generator selects a model from the model candidate set. The goal is to select one model for deployment. In an embodiment, since all of the models in the model candidate set satisfy the application constraints and the operator policies, the deployment plan generator may randomly select a model from the model candidate set. In another embodiment, the deployment plan generator selects a model based on some criteria such as the model accuracy. The flow then moves to operation 670.

At operation 670, the deployment plan generator determines whether at least one candidate exists in each candidate set. If at least one candidate exists in each candidate set, then the flow moves to operation 680. Otherwise, if at least one candidate does not exist in each candidate set, then this means that the deployment plan generator was not able to find a <model, data source, site> combination that satisfies the application requirements and operator policies, and thus the method ends with the deployment plan generator outputting a “deployment failure” message. In such a case, a change to the application requirements and/or operator policies may be needed.

At operation 680, the deployment plan generator generates a deployment plan based on the selected model. This may involve selecting one or more data sources from the candidate set of data sources and selecting one or more sites from the candidate set of sites. The generated deployment plan may specify the selected model, the selected one or more data sources, and the selected one or more sites. The method outputs the generated deployment plan.

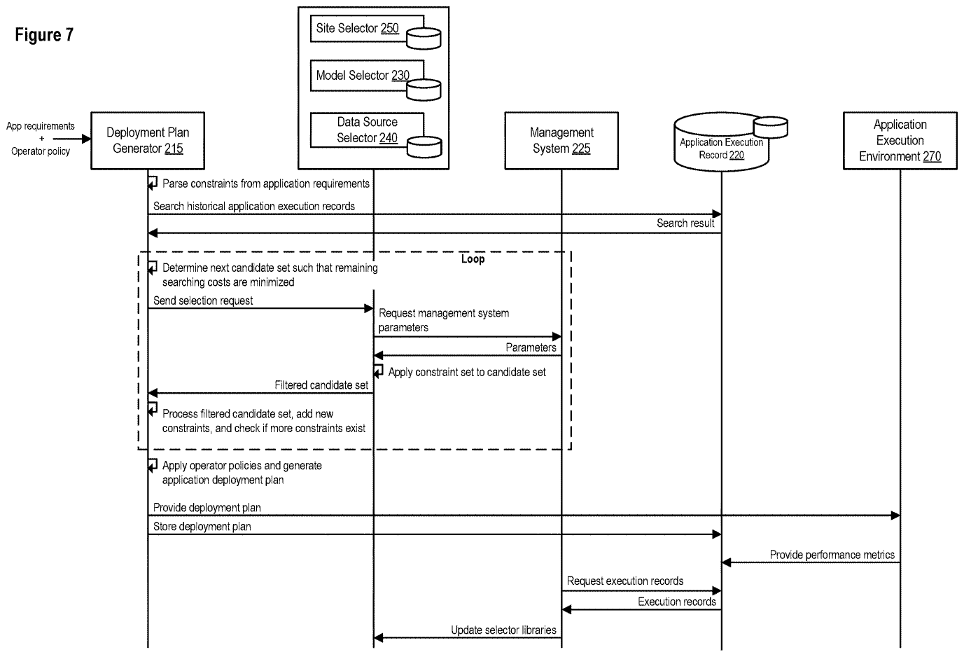

FIG. 7 is a diagram showing a sequence of operators for deploying an application, according to some embodiments.

The deployment plan generator 215 obtains the application requirements (for the application to be deployed) and operator policies (e.g., from an end user such as a cloud operator). The requirements may include the AI/ML application purpose (e.g., prediction, detection), KPI parameters, constraints (e.g., in terms of cost, location, etc.), model requirements (e.g., in terms of accuracy, type, etc.), and/or optimization objectives.

The deployment plan generator 215 parses the constraint sets from the application requirements. The constraint sets may include a constraint set for models, a constraint set for data sources, and a constraint set for sites.

The deployment plan generator 215 searches historical application execution records stored in the application execution record database 220 for previously-generated deployment plans that were generated based on requirements/constraints that are similar to the requirements/constraints of the application to be deployed. If the deployment plan generator 215 finds such a deployment plan that has a success rate that is greater than a threshold success rate, the deployment plan generator 215 may decide to reuse the deployment plan. Otherwise, the deployment plan generator 215 may generate a new deployment plan for the application. In this example, it is assumed that the deployment plan generator 215 decides to generate a new deployment plan.

As shown in the diagram, a loop may be entered. The deployment plan generator 215 determines the next candidate set such that estimated remaining searching costs are minimized. In an embodiment, this operation may involve the use of AI/ML techniques that estimate the remaining searching cost, as described elsewhere herein.

The deployment plan generator 215 sends a selection request to the appropriate selector (the selector corresponding to the candidate set).

The selector requests management system parameters from the management system 225 and obtains the parameters from the management system 225. The management system 225 may be an AI/ML management system that is responsible for AI/ML pipeline and model lifecycle management. The management system parameters may include model performance, model resource consumption, data source information, model execution site information, etc.

The selector applies the constraint set to the candidate set to filter the candidate set and provides the filtered candidate set to the deployment plan generator 215.

The deployment plan generator 215 processes the filtered candidate set, adds any new constraints generated as a result of the filtering, and checks if any further constraints exist. If further constraints exist, then the deployment plan generator 215 may repeat the operations of the loop. The deployment plan generator 215 may repeat the operations of the loop until all constraints have been applied. At the end of the loop, the deployment plan generator 215 may have produced filtered candidate sets including a filtered candidate set of models, a filtered candidate set of data sources, and a filtered candidate set of sites. Any combination of <model, data source, site> selected from the filtered candidate sets should satisfy the application requirements.

The deployment plan generator 215 applies any applicable operator policies to the filtered candidate sets and generates a deployment plan for the application (e.g., as described elsewhere herein).

The deployment plan generator 215 provides the deployment plan to the application execution environment 270 and stores the deployment plan in the application execution record database 220. The application execution environment 270 deploys the application in accordance with the deployment plan (e.g., by training the selected model using the selected data sources and deploying the trained model at the selected sites) and executes the application.

The application execution environment 270 may monitor the execution of the application and provide performance metrics of the application execution for storing in the application execution record database 220 (along with the deployment plan that was used to deploy the application).

The management system 225 requests execution records from the application execution record database 220 and obtains the execution records from the application execution record database 220. The management system 225 updates its parameters accordingly. The management system 225 updates the selector libraries with the execution results of the deployment plan. For example, the management system 225 may update the execution record of the deployed application with the list of selected data sources/sites/models and their corresponding success rate.

An example use case is now described to further illustrate an embodiment. In this example, it is assumed that a cloud operator wishes to forecast the load (e.g., CPU, memory, and network load) on its servers (e.g., servers at edge sites) every minute for the next 30 minutes. The cloud operator may specify that the training data does not need to come from a specific site but could come from several sites (e.g., the more sites, the more generalized the model).

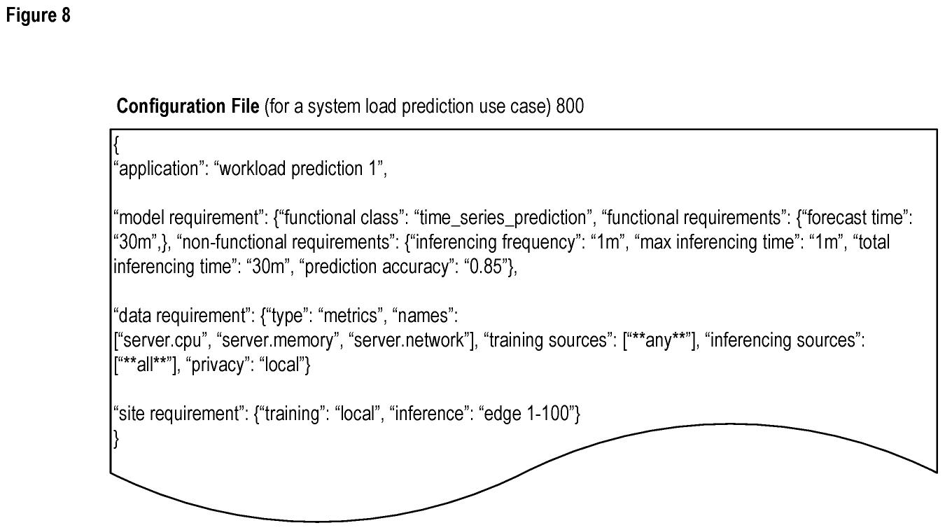

FIG. 8 shows a configuration file that summarizes the application requirements of the example system load forecasting use case, according to some embodiments. The input requirements may include functional and non-functional requirements for models, data sources, and sites.

As shown in the diagram, the configuration file 800 indicates that the application name is “workload prediction 1.” The configuration file 800 further indicates the model requirements, the data requirements, and the site requirements.

The model requirements indicate the function class of the model (“time_series_prediction”), the functional requirements of the model (forecast time is 30 minutes), and non-functional requirements of the model (the inference frequency is one minute, the maximum inferencing time is one minute, the total inferencing time is 30 minutes, and the required prediction accuracy is 0.85 (e.g., on a scale of 0 to 1)).

The data requirements indicate that the type of data to be collected is “metrics”, the specific names of the metrics are “server.cpu,” “server.memory,” and “server.network”, the training data can be collected from any selected site, the inferencing data can be collected from all selected sites, and the data privacy is “local”.

The site requirements indicate that the model is to be trained locally (at the same location as the data sources) and that inferencing is to be performed at edge sites 1 to 100.

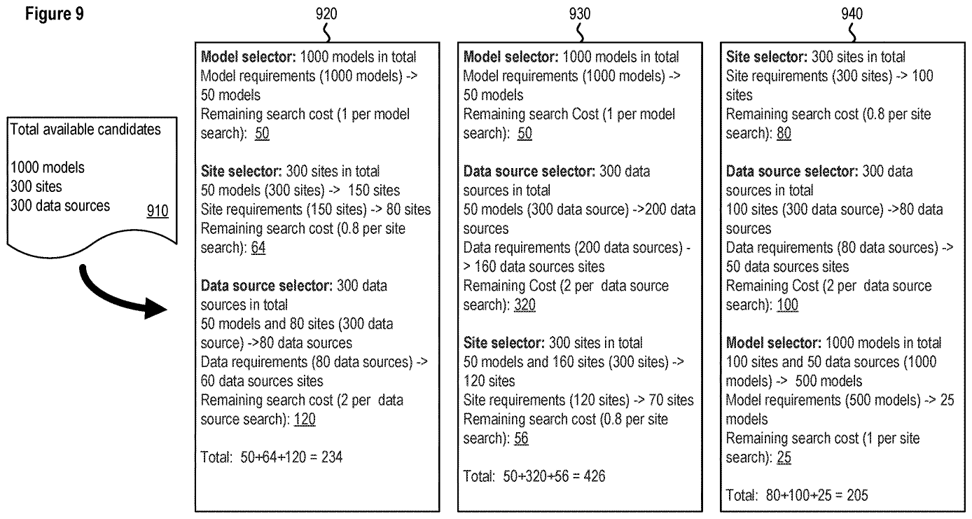

FIG. 9 is a diagram showing an example deployment plan generation, according to some embodiments.

The procedure includes two steps: remaining searching costs minimization and operator policies optimization.

The diagram shows examples of the remaining searching costs for different sequences of model, data source, and site.

The first sequence 920 is a sequence of model-site-data source. In the first sequence 920, the model selector begins with 1,000 total models. After applying the model requirements (constraint set for models), the number of models is reduced from 1,000 to 50. The remaining searching cost for models is 50 (assuming that the searching cost is one per model search).

The site selector begins with 300 total sites. After excluding any sites that are not compatible with the 50 remaining models, the number of sites is reduced from 300 to 150. After applying the site requirements (constraint set for sites), the number of sites is further reduced from 150 to 80. The remaining searching cost for sites is 64 (assuming that the searching cost is 0.8 per site search).

The data source selector starts with 300 total data sources. After excluding any data sources that are not compatible with the 50 remaining models and the 80 remaining sites, the number of data sources is reduced from 300 to 80. After applying the data source requirements (constraint set for data sources), the number of data sources is further reduced from 80 to 60.

The remaining searching cost for data sources is 120 (assuming that the searching cost is two per data source search). Thus, the total remaining searching costs for the first sequence (model-site-data source) is 234.

The searching costs for the other sequences can be determined in a similar manner as described above. In this example, the remaining searching costs for the second sequence 930 (model-data source-site) is 426, the remaining searching costs for the third sequence 940 (site-data source-model) is 205, the remaining searching costs for the fourth sequence 950 (site-model-data source) is 200, and the remaining searching costs for the fifth sequence 960 (which can be a sequence that begins with the data source) is 500.

In this example, it is assumed that the fourth sequence 950 (site-model-data source) produces the minimum remaining searching costs. Thus, the deployment plan generator may apply constraint sets to corresponding candidate sets in this sequence. This results in generating a filtered candidate set of sites with 100 sites, a filtered candidate set of models with 30 models, and a filtered candidate set of data sources with 45 data sources.

In the operator policies optimization step, the deployment plan generator applies the operator policy of “minimal resource usage” to the filtered candidate sets. In this example, it is assumed that the deployment plan generator determines that model “CNN50” uses minimal resources. Thus, the deployment generator generates a deployment plan 970 based on model “CNN50”. The deployment plan 970 specifies that model “CNN50” is to be trained using data from 45 data sources (locally at the data sources) and that the trained model is to be deployed to the 100 sites for inferencing. Note that in some cases when there is a need for ensemble learning (i.e., to ensemble learning from 45 models), some techniques such as averaging the hyper parameters can be used.

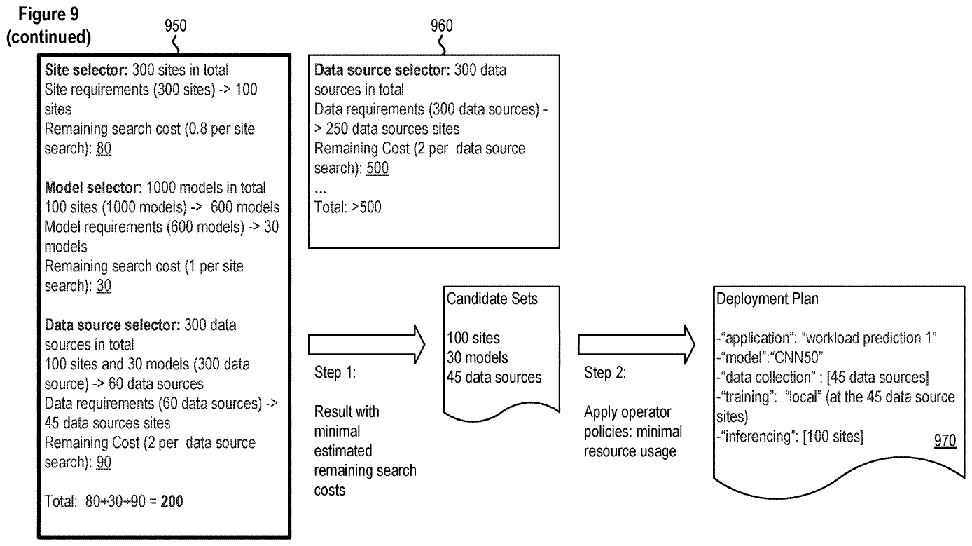

FIG. 10 is a flow diagram of a method for generating a deployment plan for a machine learning-based application, according to some embodiments.

The operations in this flow diagram and other flow diagrams included in the present disclosure are described with reference to the example embodiments of the other figures. However, those skilled in the art will appreciate that the operations of the flow diagrams can be performed by embodiments other than those discussed with reference to the other figures, and that the embodiments discussed with reference to these other figures can perform operations different than those discussed with reference to the flow diagrams.

At operation 1010, the one or more computing devices obtains constraint sets of the application including a constraint set for models, a constraint set for data sources, and a constraint set for sites. In an embodiment, the constraint sets are obtained based on parsing At operation 1020, the one or more computing devices obtain candidate sets including a candidate set of models, a candidate set of data sources, and a candidate set of sites.

At operation 1030, the one or more computing devices filter the candidate sets based on applying the constraint sets to corresponding candidate sets in a sequence that minimizes estimated remaining searching costs. The filtering results in generating filtered candidate sets including a filtered candidate set of models, a filtered candidate set of data sources, and a filtered candidate set of sites. In an embodiment, the sequence that minimizes the estimated remaining searching costs is determined using machine learning techniques. In an embodiment, applying the constraint sets to corresponding candidate sets causes a further constraint to be added to at least one constraint set.

In an embodiment, the one or more computing devices apply operator policies to the filtered candidate sets.

At operation 1040, the one or more computing devices select a model from the filtered candidate set of models. In an embodiment, the model is randomly selected from the filtered candidate set of models. In an embodiment, the model is selected from the filtered candidate set of models based on model accuracy (e.g., the model having the highest model accuracy is selected).

At operation 1050, the one or more computing devices select a model from the filtered candidate set of models.

At operation 1060, the one or more computing devices select one or more data sources from the filtered candidate set of data sources.

At operation 1070, the one or more computing devices select one or more sites from the filtered candidate set of sites.

In an embodiment, at operation 1080, the one or more computing devices provide the deployment plan to an application execution environment. The application execution environment may deploy the application according to the deployment plan and execute the application.

In an embodiment, the one or more computing devices store the deployment plan and performance metrics associated with the deployment plan (e.g., the performance metrics of the application that was deployed using the deployment plan).

In an embodiment, the one or more computing devices search historical application execution records for a previously generated deployment plan that was generated based on constraint sets similar to the constraint sets of the application. The one or more computing devices may determine whether the previously generated deployment plan has a success rate that is greater than a threshold success rate. The one or more computing devices may determine to reuse the previously generated deployment plan if the success rate is greater than the threshold success rate. Otherwise, if the success rate is not greater than the threshold success rate, the one or more computing devices may determine that a new deployment plan is to be generated for the application.

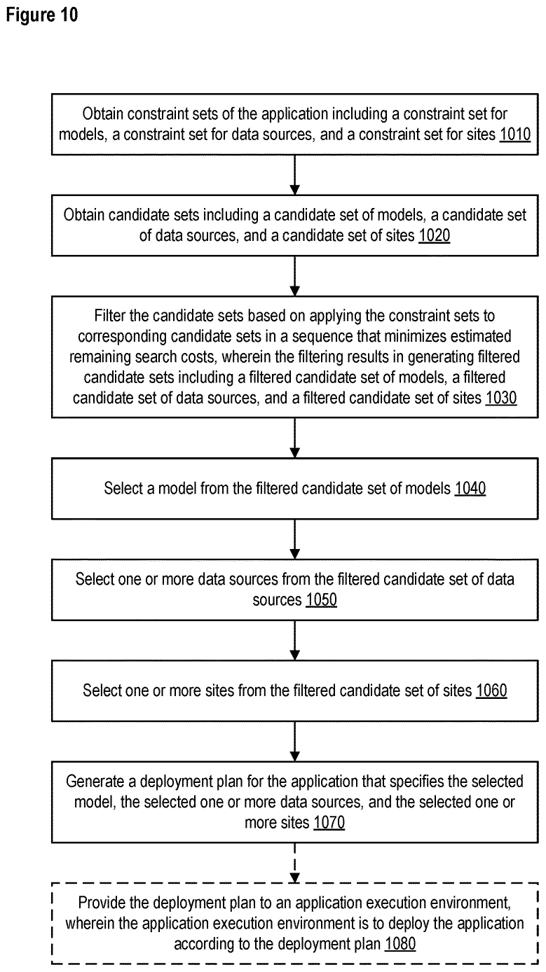

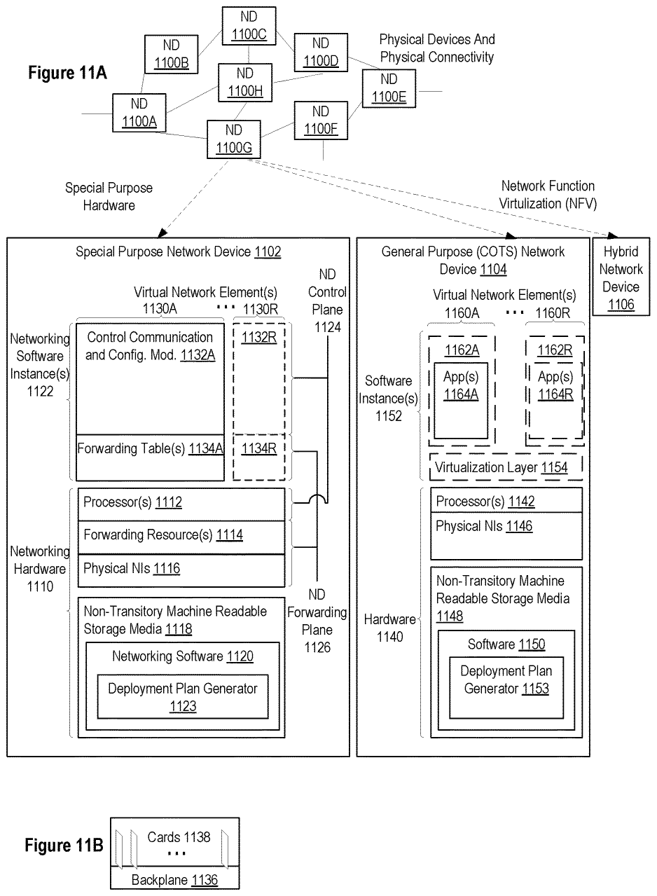

FIG. 11A illustrates connectivity between network devices (NDs) within an exemplary network, as well as three exemplary implementations of the NDs, according to some embodiments of the invention. FIG. 11A shows NDs 1100A-H, and their connectivity by way of lines between 1100A-1100B, 1100B-1100C, 1100C-1100D, 1100D-1100E, 1100E-1100F, 1100F-1100G, and 1100A-1100G, as well as between 1100H and each of 1100A, 1100C, 1100D, and 1100G. These NDs are physical devices, and the connectivity between these NDs can be wireless or wired (often referred to as a link). An additional line extending from NDs 1100A, 1100E, and 1100F illustrates that these NDs act as ingress and egress points for the network (and thus, these NDs are sometimes referred to as edge NDs; while the other NDs may be called core NDs).

Two of the exemplary ND implementations in FIG. 11A are: 1) a special-purpose network device 1102 that uses custom application-specific integrated-circuits (ASICs) and a special-purpose operating system (OS); and 2) a general purpose network device 1104 that uses common off-the-shelf (COTS) processors and a standard OS.

The special-purpose network device 1102 includes networking hardware 1110 comprising a set of one or more processor(s) 1112, forwarding resource(s) 1114 (which typically include one or more ASICs and/or network processors), and physical network interfaces (NIs) 1116 (through which network connections are made, such as those shown by the connectivity between NDs 1100A-H), as well as non-transitory machine readable storage media 1118 having stored therein networking software 1120. During operation, the networking software 1120 may be executed by the networking hardware 1110 to instantiate a set of one or more networking software instance(s) 1122. Each of the networking software instance(s) 1122, and that part of the networking hardware 1110 that executes that network software instance (be it hardware dedicated to that networking software instance and/or time slices of hardware temporally shared by that networking software instance with others of the networking software instance(s) 1122), form a separate virtual network element 1130A-R. Each of the virtual network element(s) (VNEs) 1130A-R includes a control communication and configuration module 1132A-R (sometimes referred to as a local control module or control communication module) and forwarding table(s) 1134A-R, such that a given virtual network element (e.g., 1130A) includes the control communication and configuration module (e.g., 1132A), a set of one or more forwarding table(s) (e.g., 1134A), and that portion of the networking hardware 1110 that executes the virtual network element (e.g., 1130A).

The special-purpose network device 1102 is often physically and/or logically considered to include: 1) a ND control plane 1124 (sometimes referred to as a control plane) comprising the processor(s) 1112 that execute the control communication and configuration module(s) 1132A-R; and 2) a ND forwarding plane 1126 (sometimes referred to as a forwarding plane, a data plane, or a media plane) comprising the forwarding resource(s) 1114 that utilize the forwarding table(s) 1134A-R and the physical NIs 1116. By way of example, where the ND is a router (or is implementing routing functionality), the ND control plane 1124 (the processor(s) 1112 executing the control communication and configuration module(s) 1132A-R) is typically responsible for participating in controlling how data (e.g., packets) is to be routed (e.g., the next hop for the data and the outgoing physical NI for that data) and storing that routing information in the forwarding table(s) 1134A-R, and the ND forwarding plane 1126 is responsible for receiving that data on the physical NIs 1116 and forwarding that data out the appropriate ones of the physical NIs 1116 based on the forwarding table(s) 1134A-R.

In an embodiment, software 1120 includes code such as deployment plan generator component 1123, which when executed by networking hardware 1110, causes the special-purpose network device 1102 to perform operations of one or more embodiments disclosed herein (e.g., to generate a deployment plan for an ML-based application).

FIG. 11B illustrates an exemplary way to implement the special-purpose network device 1102 according to some embodiments of the invention. FIG. 11B shows a special-purpose network device including cards 1138 (typically hot pluggable). While in some embodiments the cards 1138 are of two types (one or more that operate as the ND forwarding plane 1126 (sometimes called line cards), and one or more that operate to implement the ND control plane 1124 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL) / Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 1136 (e.g., a first full mesh coupling the line cards and a second full mesh coupling all of the cards).

Returning to FIG. 11A, the general purpose network device 1104 includes hardware 1140 comprising a set of one or more processor(s) 1142 (which are often COTS processors) and physical NIs 1146, as well as non-transitory machine readable storage media 1148 having stored therein software 1150. During operation, the processor(s) 1142 execute the software 1150 to instantiate one or more sets of one or more applications 1164A-R. While one embodiment does not implement virtualization, alternative embodiments may use different forms of virtualization. For example, in one such alternative embodiment the virtualization layer 1154 represents the kernel of an operating system (or a shim executing on a base operating system) that allows for the creation of multiple instances 1162A-R called software containers that may each be used to execute one (or more) of the sets of applications 1164A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 1154 represents a hypervisor (sometimes referred to as a virtual machine monitor (VMM)) or a hypervisor executing on top of a host operating system, and each of the sets of applications 1164A-R is run on top of a guest operating system within an instance 1162A-R called a virtual machine (which may in some cases be considered a tightly isolated form of software container) that is run on top of the hypervisor-the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1140, directly on a hypervisor (in which case the unikernel is sometimes described as running within a LibOS virtual machine), or in a software container, embodiments can be implemented fully with unikernels running directly on a hypervisor represented by virtualization layer 1154, unikernels running within software containers represented by instances 1162A-R, or as a combination of unikernels and the above-described techniques (e.g., unikernels and virtual machines both run directly on a hypervisor, unikernels and sets of applications that are run in different software containers).

The instantiation of the one or more sets of one or more applications 1164A-R, as well as virtualization if implemented, are collectively referred to as software instance(s) 1152.

Each set of applications 1164A-R, corresponding virtualization construct (e.g., instance 1162A-R) if implemented, and that part of the hardware 1140 that executes them (be it hardware dedicated to that execution and/or time slices of hardware temporally shared), forms a separate virtual network element(s) 1160A-R.

The virtual network element(s) 1160A-R perform similar functionality to the virtual network element(s) 1130A-R—e.g., similar to the control communication and configuration module(s) 1132A and forwarding table(s) 1134A (this virtualization of the hardware 1140 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 1162A-R corresponding to one VNE 1160A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 1162A-R to VNEs also apply to embodiments where such a finer level of granularity and/or unikernels are used.

In certain embodiments, the virtualization layer 1154 includes a virtual switch that provides similar forwarding services as a physical Ethernet switch. Specifically, this virtual switch forwards traffic between instances 1162A-R and the physical NI(s) 1146, as well as optionally between the instances 1162A-R; in addition, this virtual switch may enforce network isolation between the VNEs 1160A-R that by policy are not permitted to communicate with each other (e.g., by honoring virtual local area networks (VLANs)).

In an embodiment, software 1150 includes code such as deployment plan generator component 1153, which when executed by hardware 1140, causes the general purpose network device 1104 to perform operations of one or more embodiments disclosed herein (e.g., to generate a deployment plan for an ML-based application).

The third exemplary ND implementation in FIG. 11A is a hybrid network device 1106, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 1102) could provide for para-virtualization to the networking hardware present in the hybrid network device 1106.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 1130A-R, VNEs 1160A-R, and those in the hybrid network device 1106) receives data on the physical NIs (e.g., 1116, 1146) and forwards that data out the appropriate ones of the physical NIs (e.g., 1116, 1146). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended to be limiting. One having ordinary skill in the art would recognize that variations can be made to the flow diagrams.

In the foregoing specification, embodiments have been described with reference to specific exemplary embodiments thereof. It will be evident that various modifications may be made thereto without departing from the broader spirit and scope of the disclosure provided herein. The specification and drawings are, accordingly, to be regarded in an illustrative sense rather than a restrictive sense.

1. A method performed by a one or more computing devices for generating a deployment plan for a machine-learning-based application, the method comprising:
obtaining constraint sets of the application including a constraint set for models, a constraint set for data sources, and a constraint set for sites;
obtaining candidate sets including a candidate set of models, a candidate set of data sources, and a candidate set of sites;
determining a sequence in which to apply the constraint sets to the candidate sets to minimize estimated remaining search costs;
filtering the candidate sets based on applying the constraint sets to corresponding candidate sets in the determined sequence, wherein the filtering results in generating filtered candidate sets including a filtered candidate set of models, a filtered candidate set of data sources, and a filtered candidate set of sites;
selecting a model from the filtered candidate set of models;
selecting one or more data sources from the filtered candidate set of data sources;
selecting one or more sites from the filtered candidate set of sites; and
generating a deployment plan for the application that specifies the selected model, the selected one or more data sources, and the selected one or more sites.

2. The method of claim 1, further comprising:
providing the deployment plan to an application execution environment, wherein the application execution environment is to deploy the application according to the deployment plan.

3. The method of claim 2, further comprising:
storing the deployment plan; and
storing performance metrics associated with the deployment plan.

4. The method of claim 1, further comprising:
searching historical application execution records for a previously generated deployment plan that was generated based on constraint sets similar to the constraint sets of the application;
determining whether the previously generated deployment plan has a success rate that is greater than a threshold success rate; and
determining to generate a new deployment plan for deploying the application instead of reusing the previously generated deployment plan in response to determining that the previously generated deployment plan does not have a success rate that is greater than the threshold success rate.

5. The method of claim 1, wherein the sequence is determined using machine learning techniques, heuristics, or optimization-based approaches.

6. The method of claim 1, further comprising:
applying operator policies to the filtered candidate sets.

7. The method of claim 1, wherein the selected model is randomly selected from the filtered candidate set of models.

8. The method of claim 1, wherein the selected model is selected from the filtered candidate set of models based on model accuracy.

9. The method of claim 1, wherein applying the constraint sets to corresponding candidate sets causes a further constraint to be added to at least one constraint set.

10. The method of claim 1, wherein the constraint sets are obtained based on parsing application requirements.

11. A non-transitory machine-readable storage medium storing computer program code, which when executed by a computer, causes the computer to perform operations comprising:
obtaining constraint sets of an application including a constraint set for models, a constraint set for data sources, and a constraint set for sites;
obtaining candidate sets including a candidate set of models, a candidate set of data sources, and a candidate set of sites;
determining a sequence in which to apply the constraint sets to the candidate sets to minimize estimated remaining search costs;
filtering the candidate sets based on applying the constraint sets to corresponding candidate sets in the determined sequence, wherein the filtering results in generating filtered candidate sets including a filtered candidate set of models, a filtered candidate set of data sources, and a filtered candidate set of sites;
selecting a model from the filtered candidate set of models;
selecting one or more data sources from the filtered candidate set of data sources;
selecting one or more sites from the filtered candidate set of sites; and
generating a deployment plan for the application that specifies the selected model, the selected one or more data sources, and the selected one or more sites.

12. The non-transitory machine-readable storage medium of claim 11, wherein the operations further comprise:
providing the deployment plan to an application execution environment, wherein the application execution environment is to deploy the application according to the deployment plan.

13. The non-transitory machine-readable storage medium of claim 12, wherein the operations further comprise:
storing the deployment plan; and
storing performance metrics associated with the deployment plan.

14. The non-transitory machine-readable storage medium of claim 11, wherein the operations further comprise:
searching historical application execution records for a previously generated deployment plan that was generated based on constraint sets similar to the constraint sets of the application;
determining whether the previously generated deployment plan has a success rate that is greater than a threshold success rate; and
determining to generate a new deployment plan for deploying the application instead of reusing the previously generated deployment plan in response to determining that the previously generated deployment plan does not have a success rate that is greater than the threshold success rate.

15. The non-transitory machine-readable storage medium of claim 11, wherein the sequence is determined using machine learning techniques, heuristics, or optimization-based approaches.

16. The non-transitory machine-readable storage medium of claim 11, wherein the operations further comprise:
applying operator policies to the filtered candidate sets.

17. The non-transitory machine-readable storage medium of claim 11, wherein the selected model is randomly selected from the filtered candidate set of models.

18. The non-transitory machine-readable storage medium of claim 11, wherein the selected model is selected from the filtered candidate set of models based on model accuracy.

19. The non-transitory machine-readable storage medium of claim 11, wherein applying the constraint sets to corresponding candidate sets causes a further constraint to be added to at least one constraint set.

20. The non-transitory machine-readable storage medium of claim 11, wherein the constraint sets are obtained based on parsing application requirements.
